(19) United States
(12) Patent Application Publication
(10) Pub. No.: US 2003/0233453 A1
(43) Pub. Date: Dec. 18, 2003

(54) Topology probing method for mobile IP system

(75) Inventor: Chi Min Lee, Taipei (TW)

Correspondence Address: BACON & THOMAS, PLLC, 625 SLATERS LANE, FOURTH FLOOR, ALEXANDRIA, VA, 22314

(73) Assignee: Institute For Information Industry

(21) Appl. No.: 10/172,866

(22) Filed: Jun. 18, 2002

(51) Int. Cl. G06F 15/173

(52) U.S. Cl. 709/225; 709/238

(57) ABSTRACT

A topology probing method for mobile IP system is disclosed, which has a probing server, multiple clients, and multiple home agents corresponding to the clients. When the probing server sends a probing request to the client in a remote network, the client responds current resource allocation information to the probing server. The probing server establishes the network topology of the clients based on the current resource allocation information. The probing server performs a dynamic prediction based on several previous responding statuses for calculating a time interval between sending the current probing request and sending the next probing request, thereby decreasing the number of sending the probing request.

### BACKGROUND OF THE INVENTION

1. Field of the Invention

The present invention relates to a method for establishing the network topology and, more particularly, to a topology probing method for mobile IP (Internet Protocol) system.

2. Description of Related Art

Currently, the information networks are in widely spread use, and the components of the network are getting more complicated. Therefore, it is important for the network administrator to establish the network topology, so as to effectively realize the operating status of each device and resource allocation in the network, and the usage status of each network section.

Typically, there are two methods for establishing the network topology. One is based on standard protocol, such as RMON (Remote Monitoring), RMOM2, SNMP (Simple Network Message Protocol) etc. These protocols all use a detecting software or agent software executed on a monitored client for collecting and responding related information to a probing server. The other one is to define a client-server architecture, so that the user (the monitored client) can return the required information or statistical data by using the client-server architecture and communication protocol.

However, when being used in a mobile IP or wireless environment, the above two methods for establishing network topology have the following disadvantages: (1) In implementing the RMON or SNMP, it needs extra detecting or agent program for collecting information, which results in an extra burden to the device, such as PDA, that is limited in computing capacity and critical in resource allocation (memory or power allocation), and thus indirectly affects the working efficiency of other application software. (2) The developers have to implement a new protocol based on the existing protocol for supporting a new monitoring software, and thus the time to develop new products is greatly increased. (3) The current monitoring standard does not support the IP mobility, particularly the IPv6. As to the mobile host, in addition to having a constant home address, it has a care-of address that is dynamically changed by the movement of the device. Therefore, the known monitoring software which uses a single IP address is not suitable for the mobile IP environment.

Therefore, it is desirable to provide an improved network topology probing method to mitigate and/or obviate the aforementioned problems.

### SUMMARY OF THE INVENTION

An object of the present invention is to provide a topology probing method for a mobile IP system, wherein a probing server sends a probing request to a client, and processes a feedback control based on a responding state from the client, so as to decrease the number of sending the probing requests.

Another object of the present invention is to provide a topology probing method for a mobile IP system to reduce the computing load and resource allocation of the client.

Still another object of the present invention is to provide a topology probing method for a mobile IP system, wherein a client actively sends current information to it's home agent, and then the home agent forwards the current information to the probing server to establish the network topology.

In accordance with one aspect of the present invention, the topology probing method for a mobile IP system of the present invention comprises the steps of: (A) a probing server sending plural times of probing requests to a remote network system; (B) when receiving the probing requests, a client of the remote network system directly responding current resource allocation information to the probing server; (C) the probing server constructing a network location topology of the client is in the network system by the current resource allocation information returned from the client; and (D) the probing server performing a dynamic prediction process based on several previous current resource allocation information returned from the client for calculating a time interval between sending the current probing request and sending the next probing request, thereby decreasing the number of sending the probing request.

In accordance with another aspect of the present invention, the topology probing method for a mobile IP system of the present invention comprises the steps of: (A) a client actively providing current resource allocation information to a home agent of the client; (B) the home agent of the client further forwarding the current resource allocation information to a probing server; and (C) the probing server computing a network location of the client and constructs a network topology of the client by the current resource allocation information returned from the home agent of the client.

Other objects, advantages, and novel features of the invention will become more apparent from the following detailed description when taken in conjunction with the accompanying drawings.

### BRIEF DESCRIPTION OF THE DRAWINGS

FIG. 1 shows a system architecture for executing the topology probing method for mobile IP system in accordance with the first embodiment of the present invention.

FIG. 2 shows a system architecture for executing the topology probing method for mobile IP system in accordance with the second embodiment of the present invention.

### DETAILED DESCRIPTION OF THE PREFERRED EMBODIMENT

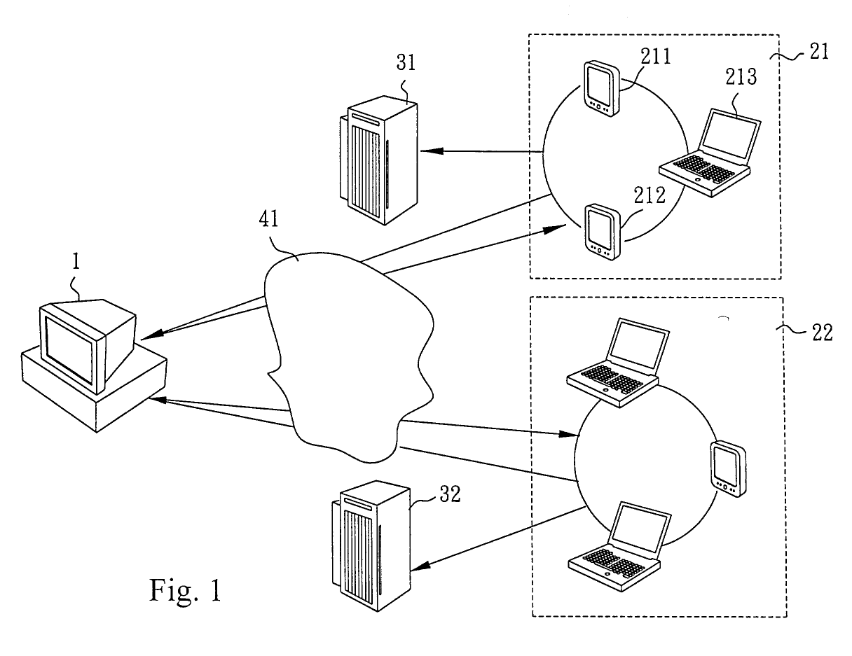

With reference to FIG. 1, there is shown the system architecture of a wireless network environment for executing the the topology probing method for mobile IP system in accordance with the first embodiment of the present invention, which includes a probing server 1, two clients 21 and 22, and two home agents 31 and 32 at the clients, respectively, wherein the client 21 further includes three portable devices 211, 212 and 213.

The above probing server 1 is a network monitor host used for establishing the network topology of the portable devices 211, 212 and 213, thereby conveniently monitoring or managing the three portable devices 211, 212 and 213. The probing server 1 is connected to the clients 21 and 22 via the Internet 41, and each of the two clients 21 and 22 is farther directly connected to its home agent 31 or 32. The portable devices 211, 212 and 213 are PDAs (Personal Digital Assistants), mobile phones, notebook computers, or other wireless mobile web devices.

The probing server 1 establishes a topology for the portable devices 211, 212, 213 as follows. The counters corresponding to the portable devices 211, 212 and 213 at each client 21 or 22 are first set up in the probing server 1. Then, the probing server 1 sends three times of probing requests to the two clients 21 and 22 in the network via the Internet 41, wherein the time interval between two probing requests is thirty seconds. It is noted that the number of requests and the interval in this embodiment are given for illustrative purpose only, and the actual values may vary depending on the actual requirement.

When receiving the probing request from the probing server 1, the clients 21 and 22 directly respond the current resource allocation information to the probing server 1. The current resource allocation information includes an Internet address where the portable devices 211, 212 and 213 are located, and the operating status of the portable devices 211, 212 and 213.

When receiving the care-of address of the current source allocation information from the portable devices 211, 212 and 213, the probing server 1 establishes the network topology for the portable devices 211, 212 and 213. The probing server 1 also performs a fuzzy feedback control operation based on the previous three times of current source allocation information responded by the clients 21 and 22. The parameters of the fuzzy feedback control operation include the following three types: (1) the response termination time of returning three previous current resource allocation information returned from the clients 21 and 22, due to the probing server 1 recording the time point whenever receiving the current source allocation information form the clients 211, 212 and 213; (2) the actual utility rate for response termination time of returning three previous current resource allocation information returned from the clients 21 and 22, which refers to the rate of the termination time returned from the portable devices 211, 212 and 213 being small than the predetermined time of the corresponding counter in the probing server 1; (3) the number of times the client 21 and 22 move to other networks, detected by the probing server 1 in three previous resource allocation information, which refers to the number of times the probing server 1 detects that the clients 21 and 22 are not at the home network.

Based on the operating mechanism, the probing server 1 computes the time interval of the subsequently probing requests, thereby decreasing the number of sending the probing request, and reducing the load of the probing server 1.

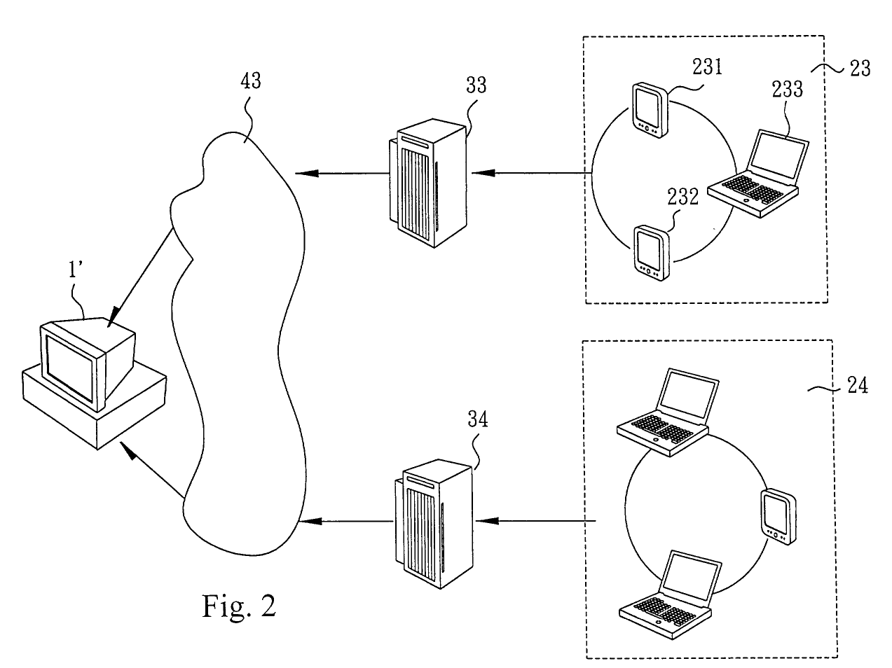

FIG. 2 shows a mobile system architecture for the second embodiment of the present invention, which includes a probing server 1′, two clients 23 and 24, and two home agents 33 and 34 at the client side. The client 23 further includes three portable devices 231, 232 and 233.

In this embodiment, the clients 23 and 24 actively send the current resource allocation information to the home agents 33 and 34, and the home agents 33, 34 forward the current resource allocation information to the probing server 1′. The probing server 1′ receives the current resource allocation information and establishes the network topology of the clients 23 and 24 by the care-of address included in the current resource allocation information, such that extra load resulted from additional probing operations can be avoided, and the probing server 1′ can be notified of the clients 23 and 24 moving to another network.

Although the present invention has been explained in relation to its preferred embodiment, it is to be understood that many other possible modifications and variations can be made without departing from the spirit and scope of the invention as hereinafter claimed.

What is claimed is:

1. A topology probing method for a mobile IP system having a probing server and a network system, the network system having a client and a home agent corresponding to the client, the method comprising the steps of:
(A) the probing server sending plural times of probing requests to the remote network system;
(B) when receiving the probing requests, the client of the remote network system directly responding current resource allocation information to the probing server;
(C) the probing server constructing a network location topology of the client is in the network system by the current resource allocation information returned from the client; and
(D) the probing server performing a dynamic prediction process based on several previous current resource allocation information returned from the client for calculating a time interval between sending the current probing request and sending the next probing request, thereby decreasing the number of sending the probing request.

2. The method as claimed in claim 1, wherein in step (B), the client further actively sends the current resource allocation information to the home agent of the client.

3. The method as claimed in claim 1, wherein the dynamic prediction process takes response termination time of returning several previous current resource allocation information received by the probing server as a computing condition.

4. The method as claimed in claim 1, wherein the dynamic prediction process takes an actual utility rate for response termination time of returning several previous current resource allocation information received by the probing server as a computing condition.

5. The method as claimed in claim 1, wherein the dynamic prediction process takes the number of times the client moves to other networks, detected by the probing server in several previous resource allocation information, as a computing condition.

6. The method as claimed in claim 1, wherein the current resource allocation information returned from the client includes a care-of address.

7. A topology probing method for a mobile IP system having a probing server, a client, and a home agent corresponding to the client, the method comprising the steps of:
(A) the client actively providing current resource allocation information to the home agent of the client;
(B) the home agent of the client further forwarding the current resource allocation information to the probing server; and
(C) the probing server computing a network location of the client and constructs a network topology of the client by the current resource allocation information returned from the home agent of the client.

8. The method as claimed in claim 7, wherein the current resource allocation information returned from the client includes a care-of address.
